(19) United States
(12) Patent Application Publication
(10) Pub. No.: US 2006/0217019 A1
(43) Pub. Date: Sep. 28, 2006

(54) Glass fiber filtration media with at least two different fiber diameters

(76) Inventor: Rodney R. Wilkins, Granville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/375,862

(22) Filed: Mar. 15, 2006

Related U.S. Application Data
(63) Continuation-in-part of application No. 11/052,411, filed on Feb. 7, 2005.
(60) Provisional application No. 60/625,028, filed on Nov. 4, 2004.

(51) Int. Cl. B32B 17/02; D04H 1/00; C03B 37/02

(52) U.S. Cl. 442/180; 65/475; 442/331

(57) ABSTRACT

A method of forming filtration media, and the media so formed. The media has glass fibers of at least two substantially different diameters, such as 18 microns and 21 microns. Each of the glass fibers is continuous throughout the media and is substantially the same diameter along its entire length. The fibers can be made using a bushing plate in the Modigliani process in which the plate has orifices of at least two different sizes. The fibers made thereby have two different sizes, thereby resulting in a filtration media superior to conventional media, despite having a similar amount of glass and no more weight. The filtration media also has microspheres, in the range of about 3 to about 40 microns, which increase holding capacity.

### CROSS-REFERENCES TO RELATED APPLICATIONS

This application is a Continuation-In-Part of U.S. patent application Ser. No. 11/052,411 filed Feb. 7, 2005, which claims the benefit of U.S. Provisional Application No. 60/625,028 filed Nov. 4, 2004.

### STATEMENT REGARDING FEDERALLY-SPONSORED RESEARCH AND DEVELOPMENT

### Not Applicable

### REFERENCE TO AN APPENDIX

### Not Applicable

### BACKGROUND OF THE INVENTION

1. Field of the Invention

This invention relates generally to filtration media, and more specifically to glass fiber filtration media.

2. Description of the Related Art

A known method for making fiberglass is described in several patents to Modigliani: U.S. Pat. Nos. 2,546,230; 2,609,320; and 2,964,439 are incorporated herein by reference. These patents disclose an apparatus in which a slowly reciprocating, melting furnace feeds molten glass through spinning orifices which discharge an array of fine, continuous glass filaments or fibers that are wrapped circumferentially around a rapidly rotating drawing drum. The melting furnace uses a bushing plate with orifices of the same size, through which the molten glass flows, to form the glass fibers.

The melting furnace reciprocates relatively slowly in a longitudinal direction above the drum's rapidly rotating circumferential surface, thereby forming a build-up of layers of continuous fibers oriented at acute angles with one another. During winding of the fibers on the rotating drum, a binder, such as a thermosetting resin, is commonly applied by spraying the fibers already deposited on the drum to bind the fibers at their overlapping junctions with fibers of previously deposited layers.

After a suitable thickness of fibers has been created, the condensed mat is removed from the drum by slitting the mat longitudinally and parallel with the axis of the drum. The condensed mat can be modified subsequently by being deposited on a conveyor belt that moves at a very slow rate. The condensed mat is generally rectangular in shape, and the fibers in the mat extend, due to the orientation of the rectangular mat on the conveyor, substantially completely across the width of the mat and substantially perpendicular to the direction of movement of the conveyor belt. At the exit end of the conveyor belt, a retarding roller presses the condensed mat against the conveyor belt, which is supported by an oppositely rotating support roller. The leading end of the condensed mat beyond the retarding roller is stretched or expanded longitudinally up to hundreds of times its original, condensed length. The expanding is a continuous process with the leading end being pulled longitudinally while the retarding roller/support structure minimizes the forward movement of the remaining length of the condensed mat.

As the mat expands longitudinally, it also expands (“fluffs”) in the direction of the mat's thickness to a consistency resembling cotton candy. Additionally, during the expansion of the mat, the fibers that are originally oriented transversely to the direction of movement are pulled longitudinally, thereby tending to rotate and reorient the fibers to a 45 degree or greater angle with respect to the longitudinal direction. During the expansion process, in which the original mat increases in length enormously and “fluffs” to a significantly greater thickness, the mat necks down to a smaller width. Such an expanded product can be used for filtration purposes, such as by attaching the product to a frame.

As an alternative to using the product as a filtration media, the product can be compressed into a dense mat to use as a fibrous reinforcement, for example, in pultruded composite products. After the majority of the expanding takes place, the fluffed, expanded mat can be compressed in the direction of its thickness by rolling, and it is heated by radiant heaters to set the thermosetting resin incorporated during the winding of the fibers on the drum. Thereafter, the stretched glass fiber mat is wound on a spool. Thus, the compressed mat, which is much longer than the original, condensed mat, is a continuous strand fiberglass mat, because the condensed mat from which it is derived was formed from continuous strands of glass.

As noted above, the glass-melting furnace of the Modigliani process machine feeds molten glass through orifices that are formed in a bushing plate. The bushing plate is a flat plate, normally made of a metal alloy, through which holes are formed and through which molten glass flows during use. The size of each orifice has a direct effect on the diameter of the fibers formed thereby. Conventionally, bushing plate holes are all the same size in order to avoid temperature gradients that are present if different size fibers were used. The process of forming fibers can thus be “tuned” to the exact characteristics desired without having to compensate for a plurality of fiber diameters, and therefore, fiber characteristics. The orifices in the bushing plates are all drilled to a size that results in a particular fiber size. Therefore, a particular drill size results, according to conventional technology, in a particular finished fiber size.

The Applicant is aware of the use of a bushing plate with orifices of two different sizes to form a condensed glass fiber mat using the Modigliani process. The condensed mat was expanded and then compressed into a thin mat in the conventional manner and sold for use in polymer-reinforced composites. The sale of this compressed mat has occurred for several years. The fibers in this mat were between 28 and 40 microns in diameter, and the compressed mat had a thickness of approximately one-quarter inch. The characteristics of this mat make it unsuitable for use as a filtration media.

It is also known to be conventional for filtration media to have different fiber diameters, but only within layers of a multi-layer web. This is accomplished by laying fibers in separate layers, and making one layer with fibers of one size, and another layer with different fibers of a different size. Furthermore, fibers made using the Modigliani process can change each fiber's size during manufacture, for example by rotating the drawing drum faster, which produces a layer of one size fiber, and then rotating the drum slower, which produces another layer of a larger size fiber. For example, one can operate at a first drum speed, and, for example, get a 30 micron fiber, and then decrease the speed to get a 36 micron fiber. However, in all of the prior art, the fibers in each layer are the same diameter, even after expansion of the original mat.

### BRIEF SUMMARY OF THE INVENTION

The invention is a method of making a filter. The method comprises extruding molten glass through a plurality of orifices formed in a plate. This forms a plurality of glass fibers, and each of the fibers extends from a corresponding one of the orifices. Furthermore, each of the plurality of orifices has one of at least two substantially different orifice diameters. In one embodiment, there are first and second fiber diameters in a range between about 17 microns and about 26 microns, and in one particular embodiment, the first diameter is about 18 microns and the second diameter is about 21 microns.

The fibers are wrapped around a rotating drawing drum to form a condensed mat, and the mat is removed from the drawing drum. The mat is expanded, such as by pulling on opposite sides thereof, thereby forming the filtration media through which gas can flow. The filtration media is then mounted in a filter frame, such as a disposable frame or the permanent frame of a gas duct.

The invention also contemplates a filtration media made of a plurality of continuous glass fibers, where each of the fibers has one of at least two substantially different diameters. Furthermore, each fiber's diameter is substantially the same throughout the filtration media. The filtration media is contemplated to have first and second diameters in a range between about 17 microns and about 26 microns, where the first diameter is about 18 microns and the second diameter is about 21 microns. The filtration media can be mounted in a gas flow path for removing particulate from gas flowing through the filtration media.

### BRIEF DESCRIPTION OF THE SEVERAL VIEWS OF THE DRAWINGS

FIG. 1 is a view in perspective illustrating a bushing plate having orifices of two sizes.

FIG. 2 is a magnified schematic view illustrating filtration media made according to the present invention.

FIG. 3 is a table showing the MERV, pressure drop and particle size efficiency values for three samples tested in experiments to ascertain the advantages of the present invention over the prior art.

FIG. 4 is a table showing the characteristics of a conventional fiberglass filter.

FIG. 5 is a graph showing the initial removal efficiency of the conventional filter for various particle sizes.

FIG. 6 is a graph showing the pressure drop for a clean conventional filter at various air flow rates.

FIG. 7 is a table showing the initial removal efficiency for the conventional filter for various particle sizes.

FIG. 8 is a table showing the filter characteristics for a filter made according to the present invention.

FIG. 9 is a graph showing the removal efficiency of the filter made according to the invention for various particle sizes and at different load quantities.

FIG. 10 is a graph showing the pressure drop for a clean filter made according to the invention at various air flow rates.

FIG. 11 is a table showing the initial removal efficiency and removal efficiency at various loads according to particle size for the filter made according to the invention.

FIG. 12 is a table showing the characteristics of a conventional pleated fiberglass filter.

FIG. 13 is a graph showing the initial removal efficiency of the conventional pleated filter for various particle sizes.

FIG. 14 is a graph showing the pressure drop for a clean conventional pleated filter at various air flow rates.

FIG. 15 is a table showing the initial removal efficiency for the conventional pleated filter for various particle sizes.

In describing the preferred embodiment of the invention which is illustrated in the drawings, specific terminology will be resorted to for the sake of clarity. However, it is not intended that the invention be limited to the specific term so selected, and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

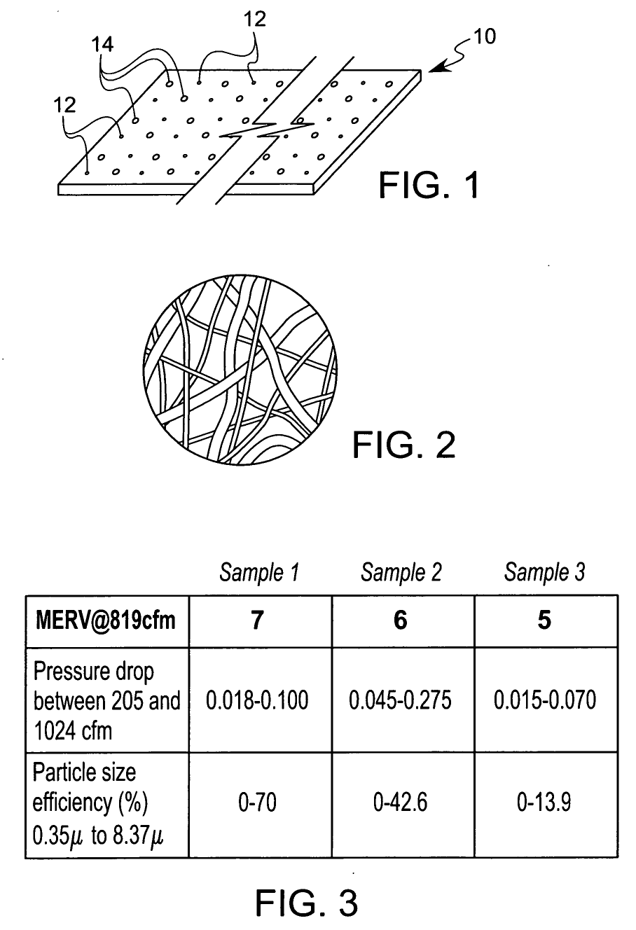

The preferred embodiment of the present invention uses a bushing plate 10, shown in FIG. 1, having orifices of at least two different sizes. In one embodiment, the smaller orifices 12 are formed by a size 25 drill resulting in an orifice diameter of 0.1495 inches, which forms fibers having a diameter in the range of about 16 to 22 microns, with an average fiber diameter of about 19 microns. The larger orifices 14 are formed using a size 22 drill resulting in an orifice diameter of 0.1570 inches, which forms fibers having a diameter in the range of about 26 to 32 microns, with an average fiber diameter of about 29 microns. Of course, the particular diameters noted herein are not the only orifice diameters. Other orifice sizes are contemplated and will be apparent to the person having ordinary skill upon examining the description herein.

The orifices are formed in rows within a rectangular region on the bushing plate 10 shown in FIG. 1. The orifices of different size alternate along each row. Therefore, each orifice 12 of a smaller size has only larger size orifices 14 closest to it, and vice versa.

Other contemplated embodiments can have three, four or more different-sized orifices in the same bushing plate, and it is contemplated that the orifices will be alternated as much as possible on the plate. It is contemplated that these orifices can range in size sufficient to form fibers in the range from about 17 microns to about 26 microns in diameter.

The bushing plate 10 is used in the conventional Modigliani process for forming a mat, and then expanding the mat to form filtration media that is used in filters. Thus, the bushing plate 10 is mounted beneath a furnace of molten glass that is directed through the orifices 12 and 14 to form cooled glass fibers that are drawn around a rotating drawing drum. These fibers form overlapping layers in a condensed mat that is then slit and removed from the drum. If a binder is used to bind the fibers together to form the mat, a formaldehyde-free binder is preferably used, although a urea formaldehyde binder could be used.

The mat formed is then expanded in the conventional manner, such as by pulling on opposing ends so that the fibers change relative orientations, which causes the fibers to “fluff up.” This expansion results in a filtration media that is slightly narrower, and significantly thicker, than the original condensed mat, but which can have one of many different thicknesses as will become apparent to a person of ordinary skill. A contemplated thickness is about one inch, because this is common for residential HVAC filtration. Different thicknesses are necessary for different applications.

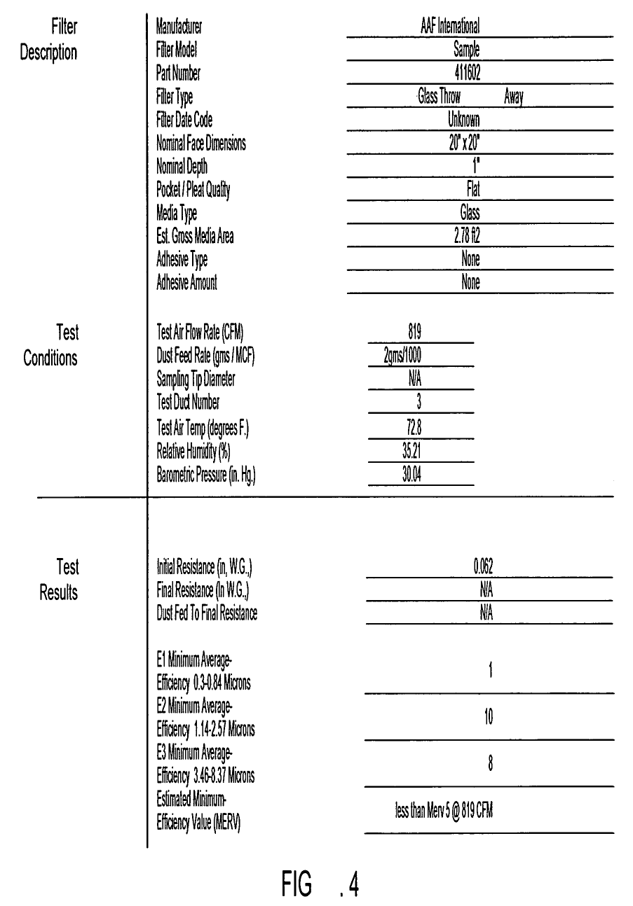

The mat formed by the bushing plate 10, and, therefore, the resulting filtration media, has larger fibers alternating with smaller fibers as shown schematically in FIG. 2. The fibers in FIG. 2 have two substantially different sizes, and the sizes and differences are exaggerated for illustrative purposes. The filtration media with these different fiber diameters is placed in a frame, such as a disposable cardboard frame, and air is forced through it. When this occurs, the smaller and larger fibers provide advantageous filtration characteristics, as shown by experimental results shown in FIG. 3. In FIG. 3, Sample 1 is the filter made according to the invention, Sample 2 is a pleated synthetic fiber filter and Sample 3 is a conventional unpleated glass fiber filter. Sample 2 and Sample 3 have one fiber diameter throughout, as is conventional. The results show that the efficiency rating, which is denoted as the Minimum Efficiency Reporting Value (MERV) obtained according to the well-known ASHRAE test 52.2, is higher for filtration media made according to the invention than with synthetic pleated and conventional glass fiber filters. This occurs while the invention has a smaller pressure drop than the pleated filter, and higher maximum particle size removal efficiency than both other filters.

It is theorized that the reason the filtration media made according to the invention is advantageous is that small cavities are formed in that cause the media to hold solid particles better than prior art filters. It is theorized that due to the size differences in the fibers, the orifices throughout the media may vary widely; i.e., the orifices have greater variations in size than in conventional filters. This could aid in holding particles of various sizes, and thereby produce superior results.

With the present invention, it is preferred that each of the fibers has the same diameter throughout the entire filter media. Thus, because there are different diameter fibers throughout the entire thickness, the fibers have different fiber diameters within every “layer” of the media. The filter of the present invention is different from conventional media, therefore, inasmuch it has two different sizes throughout the entire filter.

One application of the invention is in paint and gel coat filtration. For example, in the composite industry boats are commonly manufactured using a “spray up” process, where filters capture the over-sprayed resin. The present invention is particularly suited to this application. Of course, there are applications for this product in other industries, such as in residential heating, ventilation and air conditioning (HVAC) systems, industrial HVAC filtration, and others that will become apparent to a person of ordinary skill from this description.

It is contemplated that the filter media made according to the invention can be made in a process other than the Modigliani process. For example, in any process in which molten glass is extruded or otherwise forced, such as by gravity, through small orifices to form fibers, the present invention can be used. Thus, any structural body in which orifices are formed to pass glass through can have the plurality of different-sized orifices. The bushing plate is not the only such structure that will work.

It is also contemplated to add an antimicrobial additive to the filter media in order to kill and/or remove bacteria, viruses and other microbes from the media. Furthermore, a scented additive can also be incorporated into the filter media to release such scents into the air forced through the filter media. Still further, a dry tack oil, commonly sold under the trademark Kronitex, can be added to the filter media to enhance consistency in performance. This material is added in quantities preferably ranging from about 1.0 to about 3.0 grams per square foot of filter media.

In another embodiment of the invention, small glass microspheres are added to the filter media, preferably through the thickness dimension of the media. Adding such microspheres increases the surface area to increase the holding capacity of the filter media. This is accomplished without a significant deleterious effect on the pressure drop across the filter. The preferred microspheres have a diameter between about 3 and about 40 microns. The shape of the microspheres is generally spherical. It will be apparent to a person of ordinary skill that other microsphere shapes and sizes will work according to the invention, and that those described are only examples.

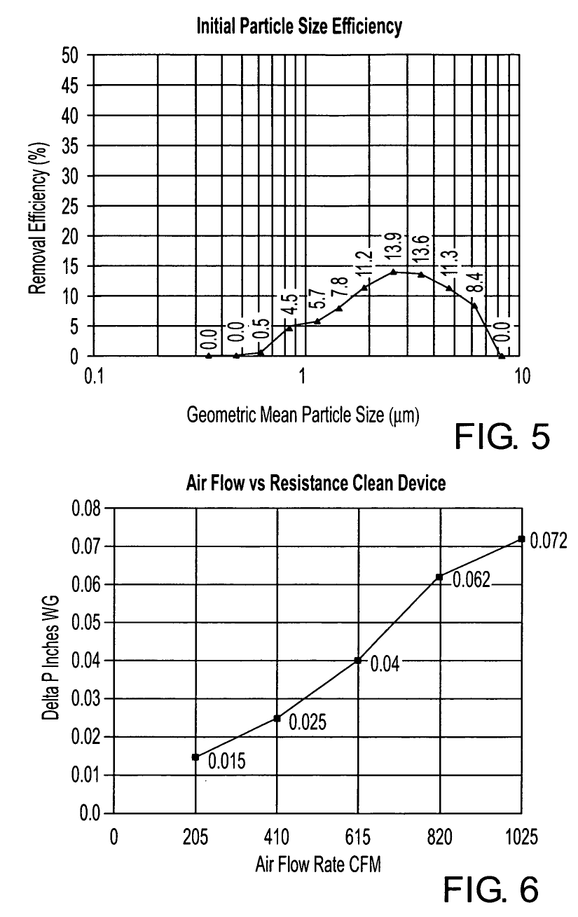

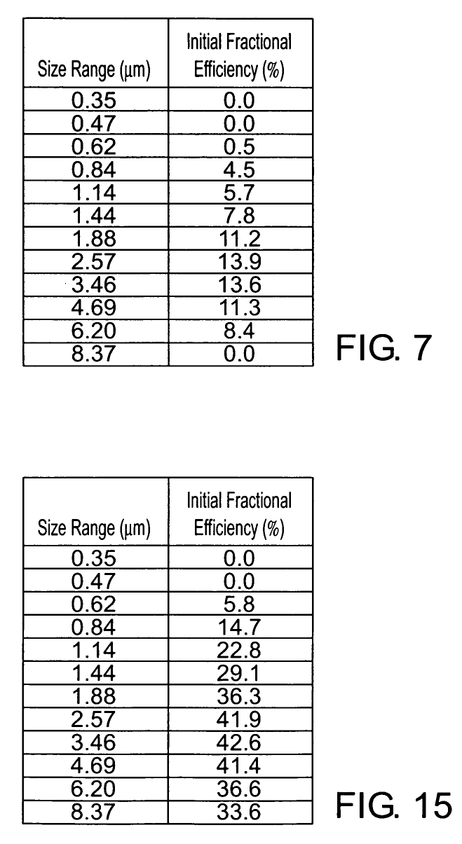

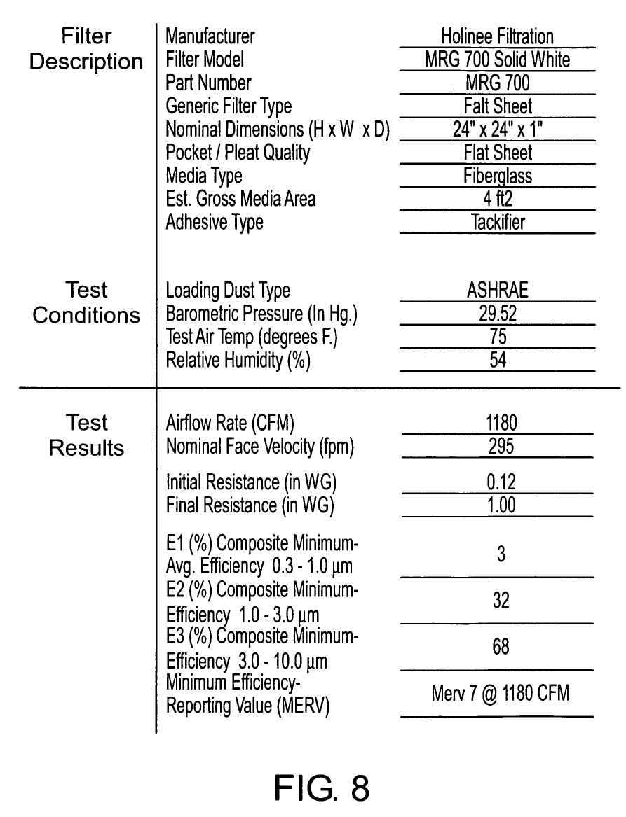

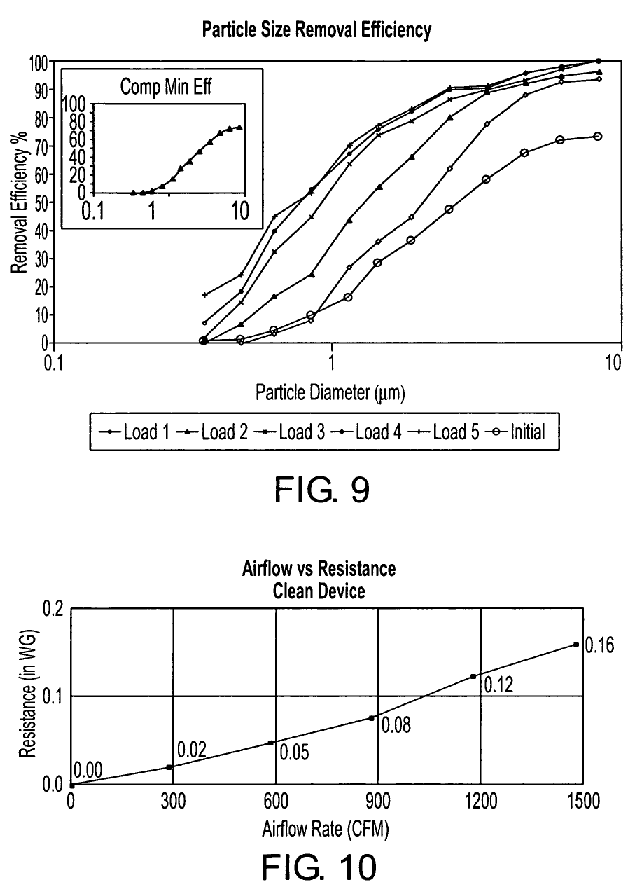

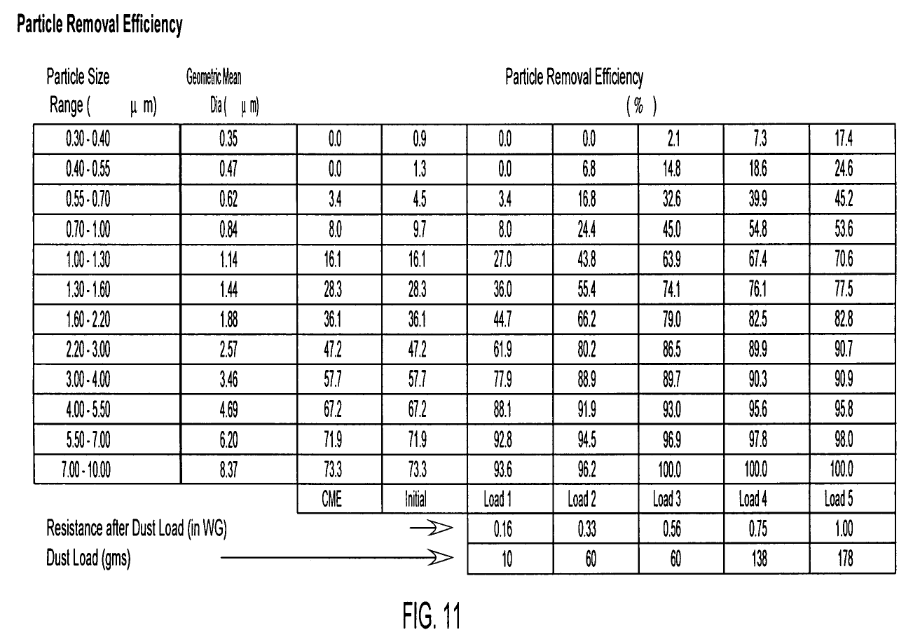

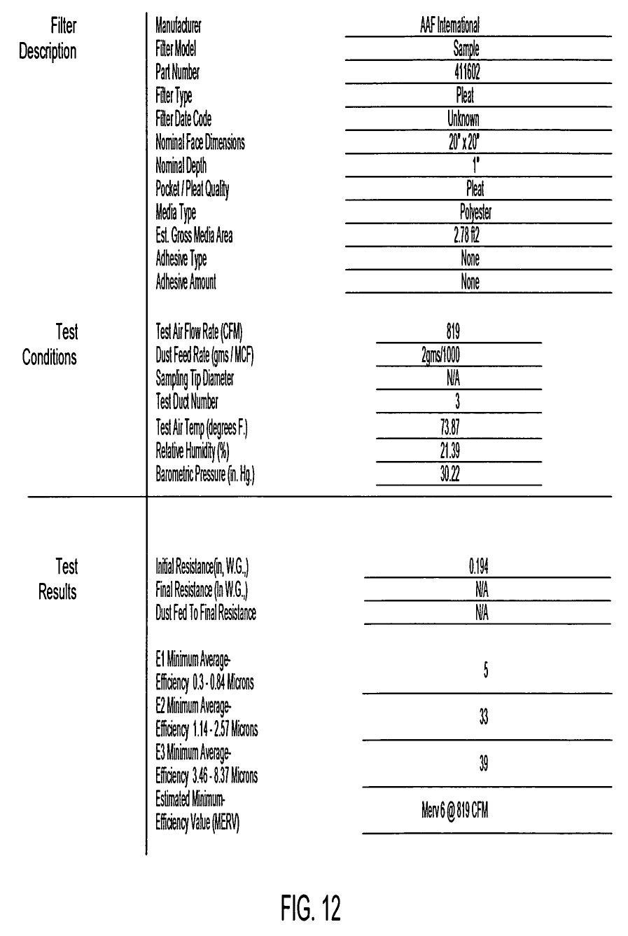

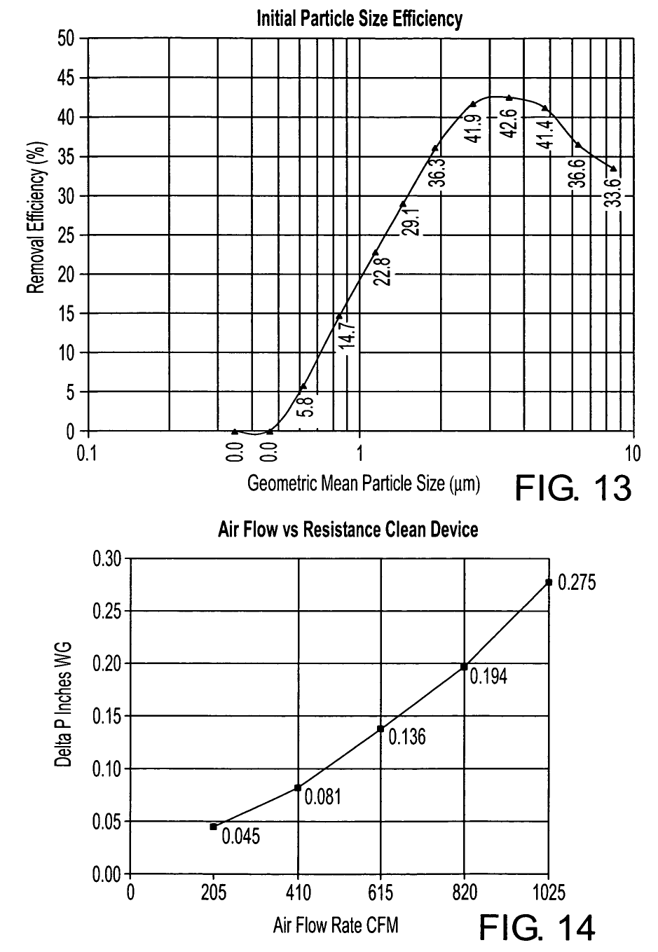

As noted above, tests were performed on the invention and a conventional filter. The results of the tests are shown in FIGS. 4-15. In FIGS. 4-7 and 12-15, the results of the tests on two conventional filters are shown, and in FIGS. 8-11, the results are shown of the same test on a filter made according to the present invention. The test performed was the ASHRAE Standard 52.2. It is apparent from the test results that the pressure drop and the removal efficiency for the invention are much better than for conventional filters, permitting the attainment of a MERV 7 rating for the invention.

While certain preferred embodiments of the present invention have been disclosed in detail, it is to be understood that various modifications may be adopted without departing from the spirit of the invention or scope of the following claims.

1. A method of making filtration media, the method comprising:
(a) disposing a container of molten glass above a rotating drawing drum;
(b) forcing molten glass through a plurality of orifices formed in a body beneath the container to form a plurality of glass fibers, wherein each of said fibers extends from a corresponding one of said orifices and each of said orifices has one of at least two substantially different orifice diameters, thereby causing each of said fibers to have one of at least two substantially different diameters;
(c) reciprocating the container while wrapping said glass fibers around the rotating drawing drum to form a condensed mat of fibers around the drawing drum;
(d) removing the condensed mat from the drawing drum;
(e) expanding the mat's exterior dimensions by applying a tensile force to at least one edge of the mat.

2. The method in accordance with claim 1, further comprising adding microspheres to the filtration media.

3. The method in accordance with claim 2, wherein the microspheres are within a size range of about 3 to about 40 microns.

4. The method in accordance with claim 3, further comprising adding a scented agent to the filtration media.

5. The method in accordance with claim 3, further comprising adding an antimicrobial agent to the filtration media.

6. The method in accordance with claim 3, further comprising adding a dry tack oil to the filtration media.

7. The method in accordance with claim 6, wherein the dry tack oil is added in a range of about 1.0 to about 3.0 grams per square foot.

8. The method in accordance with claim 1, further comprising the step of directing a flow of gas through the filtration media for removing particulate from the gas.

9. A product produced according to the process of claim 1.

10. A filtration media made of a plurality of continuous glass fibers, each of said fibers having one of at least two substantially different diameters, and wherein each fiber's diameter is substantially the same throughout the filtration media.

11. The filtration media in accordance with claim 10, wherein said at least two substantially different diameters further comprise first and second diameters in a range between about 17 microns and about 26 microns.

12. The filtration media in accordance with claim 11, wherein the first diameter is about 18 microns and the second diameter is about 21 microns.

13. The filtration media in accordance with claim 11, wherein the filtration media is mounted in a gas flow path for removing particulate from gas flowing through the filtration media.

14. The filtration media in accordance with claim 11, wherein the thickness of the filtration media is about one inch.

15. The filtration media in accordance with claim 10, further comprising microspheres within the filtration media.

16. The filtration media in accordance with claim 15, wherein the microspheres range in size between about 2 and about 40 microns.

17. The filtration media in accordance with claim 10, further comprising a dry tack oil.

18. The filtration media in accordance with claim 17, wherein the dry tack oil is in a range of about 1.0 to about 3.0 grams per square foot.
